(19) United States
(12) Patent Application Publication
(10) Pub. No.: US 2009/0283031 A1
(43) Pub. Date: Nov. 19, 2009

(54) Portable shake sprayer assembly

(76) Inventor: Michael Grasso, Ellsworth, NH (US)

Correspondence Address: MESMER & DELEAULT, PLLC, 41 BROOK STREET, MANCHESTER, NH, 03104, US

(21) Appl. No.: 12/466,475

(22) Filed: May 15, 2009

Related U.S. Application Data
(60) Provisional application No. 61/053,711, filed on May 16, 2008.

(51) Int. Cl. B05C 11/02

(52) U.S. Cl. 118/104

(57) ABSTRACT

A portable shake sprayer assembly includes a container having an upper portion, a lower portion, a bottom container opening and a top container opening, a lid removably connected to the top container opening where the lid includes an elongated lid opening, a wiping attachment disposed at the elongated lid opening, and two spraying attachments mounted to the upper portion of the container and spaced from each other where each of the two spraying attachments has a spray nozzle disposed within the container.

This application claims the benefit of U.S. Provisional Patent Application No. 61/053,711, filed May 16, 2008.

### BACKGROUND OF THE INVENTION

1. Field of the Invention

The present invention relates generally to paint and/or preservative application devices. Particularly, the present invention relates to portable paint and/or liquid preservative application devices.

2. Description of the Prior Art

Painting and finishing contractors often need to perform jobs where numerous articles require painting or staining. The use of paint application devices is well known. This is commonly done using a rag, sponge, brush, or spray gun to deposit the desired coating on the articles, and then sometimes removing any excess coating from the articles by wiping them with a rag or paint roller.

This type of work can be messy and wasteful, particularly where the liquid coating is applied using a spray gun. A significant amount of the coating may be lost to overspray where the overspray fails to land on the article to be coated. Where a spray application is not used, mess and loss can occur where more coating is applied than needed and from the coating dripping from the articles. In general, the faster the application method, the greater the waste of the liquid coating and the greater the time that will later be lost to cleanup.

Several devices have been described that alleviate the overspray problem. U.S. Pat. No. 7,029,533 (2006, Hedding) discloses a spray box for applying stain, paint or other coatings to boards. The spray box provides a portable enclosure through which trim, molding, and other boards are passed for spraying a liquid coating. A board enters a passage opening at one end of the spray box, is sprayed by spray nozzles provided in the spray box, and then exits a passage opening at an opposing end of the spray box. Rollers transport the board through the spray box where excess spray is collected at a drain hole and re-circulated back to the spray nozzles for reuse.

U.S. Pat. No. 6,613,147 (2003, Nieto) discloses a portable spray booth for applying paint to plank-like members. The portable spray booth includes a housing with a top wall, a bottom wall, a front wall, a back wall, and a pair of lateral side walls. The front and back walls each have an opening. The openings in the front and back walls are aligned and are positioned generally between the top and bottom walls. A delivery pipe is positioned in the housing and extends around the interior of the housing. A plurality of nozzles is fluidly coupled to the delivery pipe and extends through one of the lateral side walls. A pump is fluidly coupled to a container for pumping paint out of the container and is in communication with the delivery pipe.

These devices, however, are not suited for use with cedar shakes since the shakes are relative short and could not be easily manipulated through the spray boxes using the side openings.

For cedar shake applications, painting the shakes is problematic. The typical shake application has numerous gaps between adjacent shakes, which require dabbing paint into all of those gaps. This process ruins the brushes and drips are a constant headache as excess paint in the gaps regularly run down the face of the shakes. One issue with coating cedar shakes after the shakes are installed is that the paint/coating is not on critical parts of the shakes that get wet. The gap between the shakes acts like a miniature funnel in a driving rainstorm. Water can only go down or sideways and often does penetrate under the shakes. When the water soaks into the bare wood of the shakes, it dissolves chemicals in the cedar. The colored water often runs down and out of the shakes after a storm causing pesky chemical stains on the shakes. The moisture can also cause the paint to bubble and flake off at a later date.

To avoid these problems, there are a number of ways to paint the shakes before they are installed. Spraying or dipping the shakes is the most productive method. Although there are some very good airless paint sprayers that can spray shakes very quickly, the challenge is creating a spray-paint booth to minimize paint over spray. This is typically done by using a few large-appliance cardboard boxes or draping sheets of plastic to create a small room. A disadvantage of this type of spraying is the creation of a high concentration of fumes caused by the solvent in the coating and the waste of liquid coating lost to overspray.

To dip the shakes, four gallons of paint are poured into a five-gallon bucket. Each shake is then dipped into the paint by holding it at the thin top edge and dipping into the paint to within two inches of the top of the shake. Excess paint is removed from the shake using a paint brush while it is being held over the bucket. A disadvantage of the dipping method is it is time consuming since the coating process applies too thick of a coating that then must be brushed off.

Therefore, what is needed is a device that easily paints a relatively short article such as a shake and/or shingle while insuring an even coating on all sides of the article and prevents waste by overspray.

### SUMMARY OF THE INVENTION

It is an object of the present invention to provide a device that is portable and easily paints a short article while insuring an even coating on all sides and prevents waste of the paint caused by overspray.

The present invention achieves these and other objectives by providing a portable article sprayer and method that includes inserting an article through an opening in a container, spraying a coating on all sides of the article while the article is in the container and withdrawing the article through the same opening in the container after a predefined amount of time that insures an even coating on all sides of the article.

The present invention also provides a consumer, professional painter or other persons an easy, fast, and effective way to treat shakes or shingles with preservative prior to installation in the field. The conventional methods available to the smaller contractor are limited to time consuming and inefficient procedures that do not yield a professional product. Large scale, pre-stain operations are not accessible for the smaller jobs needed by some consumers. The present invention is usable by anyone with limited training and produces a professional application faster than conventional dipping methods. It is portable and usable on the job site. The present invention can be thought of as a sprayer or compressor attachment used in conjunction with products already available.

The general structure of the present invention includes a container of a pre-defined width and shape to allow for space between the shake/shingle and the sprayer nozzles. The container is also adapted to provide a way to capture a substantial quantity of overspray and allow it to be reused if needed, eliminating waste. The container preferably includes a venting system to draw out fumes and pass them through a series of filters, thus eliminating fumes that are a danger to the work area in other current methods. The container has a lid or cover that includes an elongated opening that serves as a shake/shingle port allowing access into the spray container. The spray nozzles are angled relative to the longitudinal axis of the opening to create a full coverage spray to coat all the sides and bottom of the shake/shingle as it is inserted into and withdrawn from the elongated opening of the container. The application of the liquid coating/preservative may be manually or electronically controlled to allow the sprayer or compressor to maintain a constant delivery pressure.

In one embodiment, the portable article sprayer assembly includes a container with an upper portion, a lower portion that is preferably downwardly tapered toward the middle of the container, a bottom container opening, and a top container opening. A lid is removably connected to the top container opening and includes an elongated lid opening. Two spraying attachments are mounted to the upper portion of the container and spaced from each other where each of the two spraying attachments has a spray nozzle disposed within the container. The bottom container opening serves as a drain to let the overspray of the liquid coating drain back into the supply that feeds the spray nozzles. The tapered lower portion facilitates the collection of the liquid coating to the bottom container opening.

In another embodiment of the present invention, a wiping attachment is disposed at the elongated lid opening of the lid to wipe any excess coating from the article being spray coated as the article is withdrawn from the container.

In another embodiment of the present invention, the container lower portion is releasably connected to the upper portion of the container and is optionally configured for being disposable.

In a further embodiment of the present invention, the spray attachments are optionally adjustable and each spray nozzle is angled downwardly away from the top container opening.

In a yet another embodiment of the present invention, the lid includes a vent opening with a detachable vent hose for removing fumes from the work area that are created by the solvent of the liquid coating.

In a yet a further embodiment of the present invention, a filtering screen disposed at or adjacent the bottom container opening to filter the coating liquid before reuse.

In another embodiment of the present invention, the portable article sprayer includes a fluid divider having a fluid inlet and two fluid outlets where each of the two fluid outlets is in fluid communication with one of the two spraying attachments.

In yet another embodiment of the present invention, the two sprayer attachments are spray guns having triggers connected to an activation mechanism for simultaneous activation of each of the spray guns.

The present invention combines the advantages of spraying the shakes with the act of the dipping/inserting the shakes through the elongated opening in the lid while assuring complete coverage of the shake with the sprayed liquid. Another advantage of the present invention is the ability to attach and use a conventional airless spray gun or a compressed-air spray gun to the portable article sprayer. Thus, there is no special, custom-made spray gun required to be used with the present invention. A further advantage of the present invention is the portability of the container and the ease of assembly for painting shakes and/or shingles.

In summary, the portable shake sprayer assembly controls overspray during use, drains the over-spray coating fluid from the container of the assembly for re-use and reduces waste of coating fluid, positions the spray tips of the spray attachments at a correct angle relative to the article being coated to assure complete coverage, and further optionally positions the spray tips at a downwardly angle away from the elongated opening in the lid to further protect the user from over-spray. The lid of the sprayer assembly is removable for maintenance and cleaning of the container, is rotatable as needed to facilitate better coverage of the shake relative to the position of the spray nozzles, includes a vent opening for an optional vent hose to remove fumes from the work area, and is adaptable for various attachments adjacent the elongated opening in the lid to brush, wipe, squeegee, etc., the excess coating from the article as it is “dipped” into and then removed from the container.

### BRIEF DESCRIPTION OF THE DRAWINGS

FIG. 1 is a perspective view of the present invention showing a portable sprayer assembly.

FIG. 2 is a cross-sectional view of the container of the present invention shown in FIG. 1.

FIG. 3 is a top view of the container of the present invention illustrated in FIG. 1 and showing the inside of the container and the relative position of the spray nozzles to the elongated lid opening.

FIG. 4 is a top view of the container of the present invention illustrated in FIG. 3 and showing the lid in place over the top container opening and the relative position of the spray nozzles to the elongated lid opening.

FIG. 5 is a cross-sectional view of the lid of the present invention showing the lid opening, the wiping attachment and the vent hose.

FIG. 6 is a simplified side view of another embodiment of the present invention showing two spray guns mounted to the spray container with a sidewall vent opening.

FIG. 7 is a top view of the embodiment in FIG. 5 showing a partial lid and the inside of the container.

### DETAILED DESCRIPTION OF THE PREFERRED EMBODIMENT

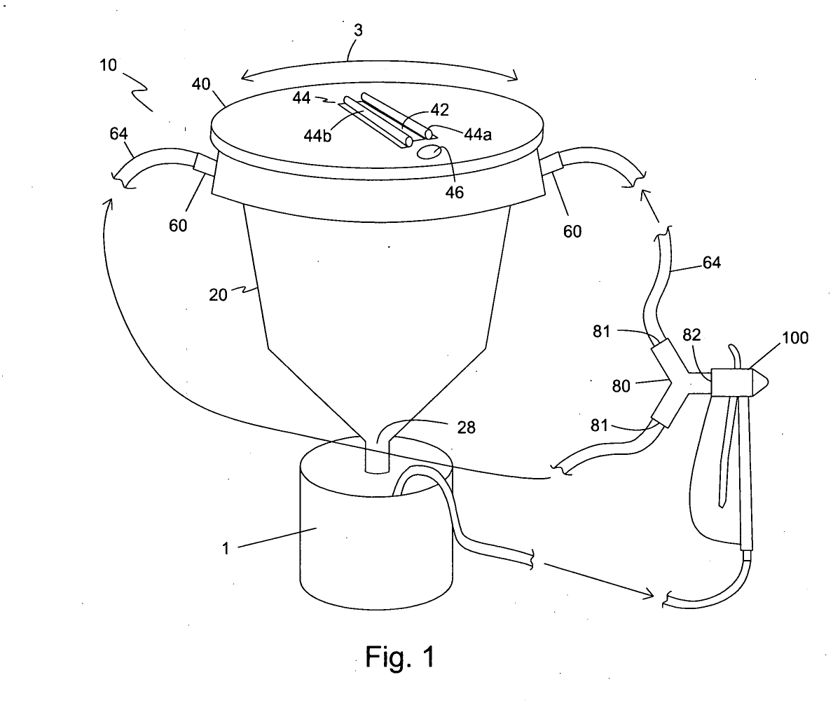

The preferred embodiment(s) of the present invention is illustrated in FIGS. 1-7. FIG. 1 shows a portable shake sprayer assembly 10. Assembly 10 includes a container 20, a lid 40 removably attached to container 20 and a pair of spray attachments 60 connected to container 20. Container 20 has an open container top 26 (not shown) and bottom container opening 28. Bottom container opening 28 serves as a liquid coating outlet to direct the overspray into a collection container 1. Spray attachments 60 are in fluid communication with a spray gun 100 to deliver a liquid coating to spray attachments 60, which sprays the liquid coating into container 20. A delivery tube 64 connects spray attachments 60 to spray gun 100, preferably through a fluid divider 80. Fluid divider 80 has two outlets 81 and one inlet 82. The liquid coating is typically paint, stain or other liquid preservative. Collection container 1 may also serve as the source of the liquid coating delivered to spray gun 100 so that the waste of liquid coating is minimized.

Lid 40 includes an elongated opening 42 and preferably an optional wiping attachment 44. Elongated opening 42 has a length and width to accommodate a shake or shingle with a limited area to minimize the escape of any overspray from spray attachments 60 out opening 42. Wiping attachment 44 is connected to lid 40 and incorporates wiping surface 44a and 44b disposed along each longitudinal side of opening 42. The separation between wiping surface 44a and 44b is narrower than the thickness of the shake or shingle in order to provide sufficient contact pressure to the shake or shingle for removing excess coating fluid as the shake or shingle is withdrawn from container 20. Wiping attachment is a resilient member such as carpet material, brushes, squeegees, and the like. Lid 40 is optionally, and preferably, rotatable as indicated by arrow 3 to allow adjustment of elongated opening 42 relative to spray attachments 60. The angle formed between the longitudinal axis of the spray attachment 60 and the longitudinal axis of elongated opening 42 is defined as the slot angle. In some types of materials and/or coatings, the slot angle is critical and needs adjustment by rotating lid 40 to provide the desired finish and color to the shake or shingle. Lid 40 also contains preferably an optional vent opening 46 to which an exhaust may be attached to remove fumes created by the solvent in the liquid coating during the spraying process away from the work area.

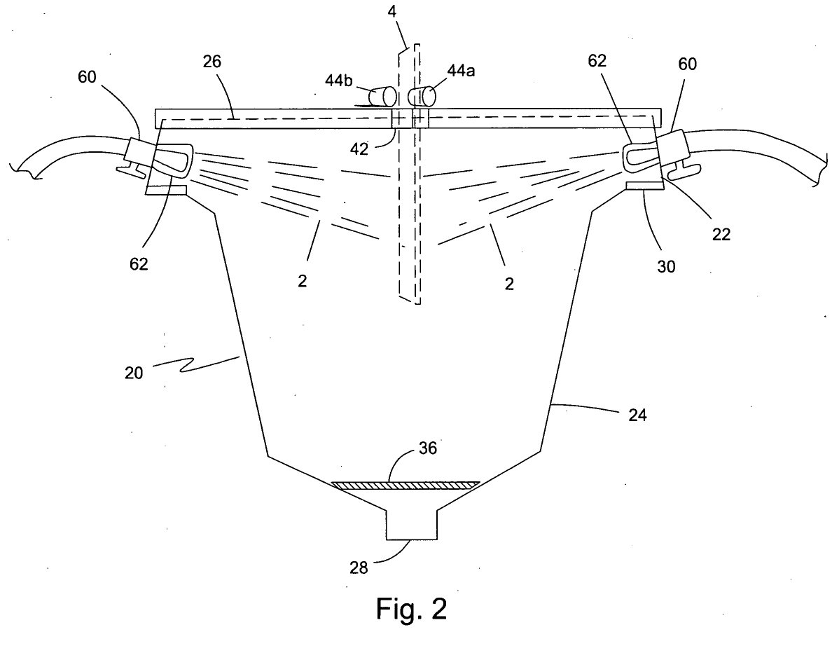

Turning now to FIG. 2, there is illustrated a side view of container 20. Container 20 has an upper portion 22 and a lower portion 24. As can be seen, upper portion 22 in this embodiment has a side wall that diverges away from top container opening 26 at a pre-defined angle to the vertical. Each spray attachment 60 is connected to upper portion 22 and includes a spray nozzle 62 that defines the type and form of spray created. Different spray nozzles provide different spray patterns. These include a full cone spray, a hollow cone spray, or a flat stream. The diverging side wall of upper portion 22 provides a surface for mounting of the spray attachment 60 with spray nozzle 62 in a downwardly disposed angle away from top container opening 26. This downwardly disposed angle is defined as the spray angle for purposes of this disclosure. An advantage of using a downward spray angle is it further minimizes the amount of overspray that can escape out of the elongated lid opening 42. Lower portion 24, on the other hand, has a side wall that converges towards the vertical. At the bottom of container 20 is bottom container opening 28. The converging side wall directs the overspray down the side wall and out bottom container opening 28. Container 20 may optionally include a filter screen 36 disposed at or adjacent bottom container opening 28. Filter screen 36 is a screen mesh to filter any articles that could clog spray gun 100 and/or spray nozzles 62, especially when the overspray is being directly collected into the supply of the liquid coating for spray gun 100. It is contemplated that filter screen 36 may be incorporated into a cap that fits over, coupled to, or inserted within bottom container opening 28, or placed within container 20. It is further contemplated that filter screen 36 may be reusable or disposable. A phantom shake or shingle 4 is shown for purposes of it relative placement within elongated opening 42 when being coated.

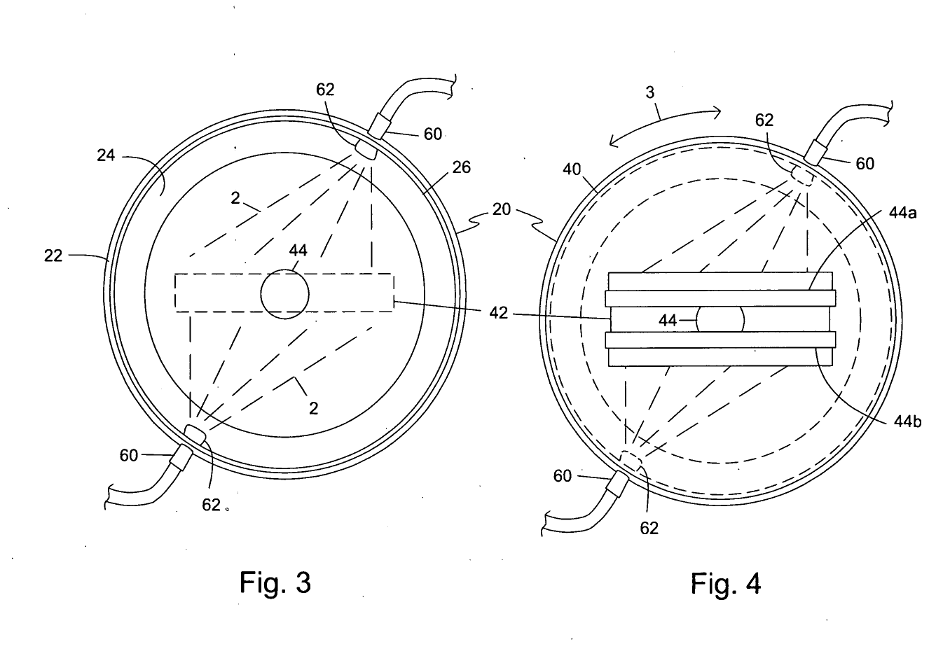

FIG. 3 illustrates a top view of container 20 with lid 40 removed. An overlay of lid elongated opening 42 is shown using dashed lines only for the purpose of showing the slot angle, i.e. the relative position of the longitudinal sides of elongated opening 42 to spray nozzles 62. As previously disclosed, top opening 26 discloses that spray attachments 60 are connected to upper portion 22 of container 20, whose side wall diverges away from the center of container 20, while the side wall of lower portion 24 converges towards the center of container 20. The diverging side wall of upper portion 22 provides a downwardly directed spray angle to spray nozzles 62. It is also understood that the side wall of upper portion 22 may also be perpendicular to top opening 26 with spray attachment 62 connected to the side wall at a pre-selected angle to provide a pre-defined downward spray angle to spray nozzles 62. As can be seen by lines 2, the spray cone from spray nozzle 62 is spaced from the center of container 20 so that the spray cone extends the length of elongated opening 42 to insure complete coverage of an inserted shake/shingle. FIG. 4 illustrates a top view of container 20 with lid 40 attached showing spray nozzles 62 in dashed lines. Arrow 3 indicates the possible rotation of lid 40 to allow a user to change the slot angle to accommodate the type of preservative used and the type of shake/shingle to be coated. Also shown is wiping attachment 44 connected to lid 40. It should be understood that the spacing between wiping member 44a and 44b is not to scale but enlarged to more easily and clearly show their spatial relationship to each other and elongated opening 42.

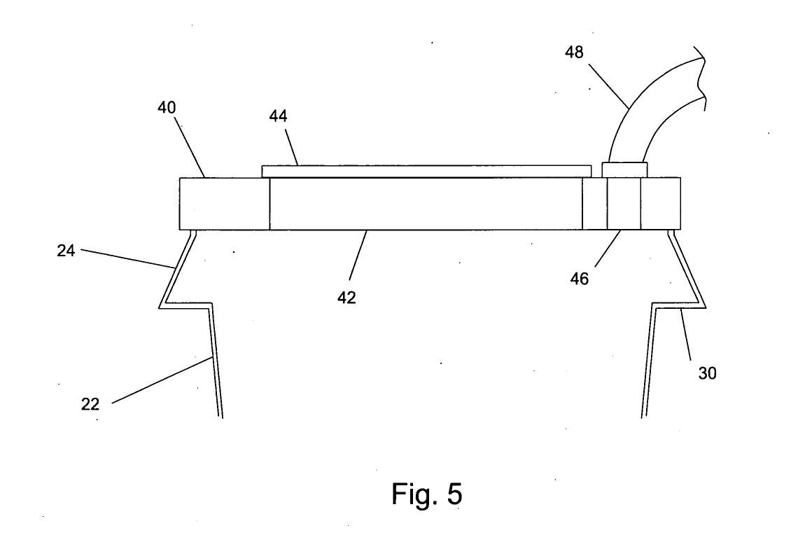

Turning now to FIG. 5, there is illustrated a cross-sectional view of the lid 40 showing the relative positions of elongated opening 42 and vent opening 46. An exhaust tube 48 is connected to vent opening 46 to remove the solvent fumes created by the liquid coating used in shake assembly 10. Wiping attachment 44 is also shown extending the length of elongated opening 42. At the junction of upper portion 22 and lower portion 24 of container 20 is a support surface 30. Support surface 30 may be used to support container 20 with a stand or sawhorses or other support structure upon which container 20 is held during use.

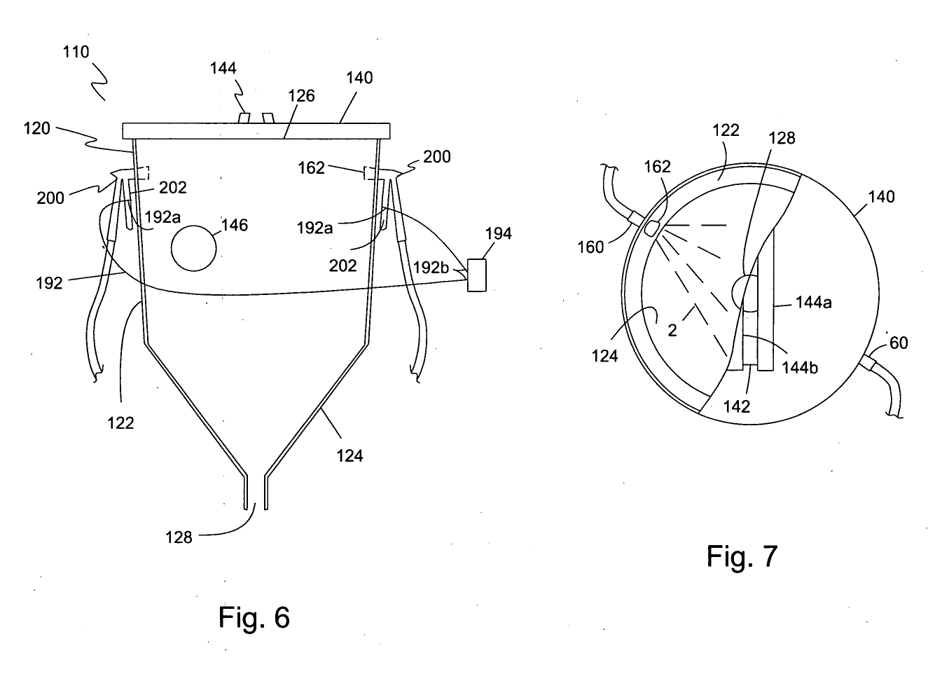

FIG. 6 illustrates another embodiment of the present invention. FIG. 6 shows a portable shake sprayer assembly 110. Portable shake sprayer assembly 110 includes a container 120, a removable lid 140, and a pair of spray guns 200. Container 120 includes an upper portion 122, a lower portion 124, a top opening 126, a bottom opening 128, and a vent opening 146. Vent opening 146 is positioned in a side wall of upper portion 122 and typically has an exhaust tubing (not shown) connected thereto. Each spray gun 200 has a spray nozzle 162 positioned within container 120. A gun activator assembly 190 is connected to the trigger portions 202 of each spray gun 200. Gun activator assembly 190 includes a trigger engaging member 192 connected to each trigger portion 202 on one end 192a and connected to an engagable member junction 194 on an opposite end 192b. By engaging member junction 194, both trigger portions 202 of spay guns 200 are simultaneously activated to begin spraying the liquid coating. This embodiment may also optionally include a filter screen (not shown) within container 120 or situated within bottom opening 128, all as previously described. To facilitate cleaning, any of the embodiments disclosed may optionally include a disposable liner within container 20.

FIG. 7 is a top view of the embodiment in FIG. 6 showing a partial lid 140. As illustrated, the longitudinal axis of elongated opening 142 of lid 140 is positioned to provide a slot angle relative to spray nozzle 162 of spray gun 200. Wiping attachment 144 has wiping portions 144a, 144b attached to lid 140 along each side of elongated opening 142. Although not drawn to scale, the spacing between wiping portions 144a, 144b is narrower than the thickness of the shake/shingle to be liquid coated so that wiping attachment 144 serves its intended purpose of wiping excess liquid coating from the shake/shingle into the container as the shake/shingle is removed. It is also contemplated that if a thicker coating is desired, wiping attachment 144 and 44 in the present invention may be removed and not used, all in accordance with the desire of the user.

Use of the portable shake sprayer assembly 10 of the present invention is relatively simple and can be set up on the job site. A conventional paint sprayer 100 is attached to the sprayer assembly 10. A user of the present invention is capable of producing a professional application that is faster than the conventional dipping process and more convenient than the conventional spray application methods while capturing the overspray for re-use and reducing waste.

To operate the present invention, a user provides a liquid coating source to a conventional paint sprayer 100. In the preferred embodiment, the sprayer nozzle is removed from the paint sprayer. A fluid divider 80 is connected to the paint sprayer outlet port and a delivery tube 64 is connected to each outlet port 81 of the fluid divider 80. The delivery tubes 64 are connected to the spray attachments 60 of the present invention, which may already be installed in the appropriate spray attachment openings in an upper portion 22 of a container 20 of the shake sprayer assembly 10. If not, then the user connects the spray attachments 60 to the spray attachment opening in the upper portion 22 of the container 20. The lid 40 is attached to the top opening 26 of the container 20 and a pre-defined slot angle is selected that sets the spray nozzles 62 of the spray attachments 60 at a pre-defined angle relative to the longitudinal axis of the elongated opening 42 in the lid 40. A collection container 1 is positioned below the bottom container opening 28 to collect the overspray from the spray nozzles 62 that collects on the side wall of container 20 and runs down to bottom container opening 28 and out of container 20. The collection container 1 may be, and is preferably, the liquid coating source so that the overspray exiting bottom container opening 28 is reused.

Spray gun 100 is activated and a shake or shingle 4 is inserted by the user into container 20 through elongated lid opening 40 and into the liquid coating spray. After a short time, the user withdraws the shake or shingle, which is coated on all sides and the bottom end. While the shake or shingle is being withdrawn, the wiping attachment 44 removes any excess liquid coating from the shake or shingle into container 20.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A portable shake sprayer assembly comprising:
a container having an upper portion, a lower portion, a bottom container opening and a top container opening;
a lid removably connected to the top container opening, the lid including an elongated lid opening;
a wiping attachment disposed at the elongated lid opening; and
two spraying attachments mounted to the upper portion of the container and spaced from each other wherein each of the two spraying attachments has a spray nozzle disposed within the container.

2. The sprayer assembly of claim 1 further comprising a spray gun in fluid communication to at least one of the two spraying attachments.

3. The sprayer assembly of claim 1 wherein each spray nozzle is angled downwardly away from the top container opening.

4. The sprayer assembly of claim 1 wherein the lid includes a vent opening with a detachable vent hose.

5. The sprayer assembly of claim 1 wherein the lid is rotatable about the top container opening.

6. The sprayer assembly of claim 1 wherein the wiping attachment includes one or more of a squeegee, roller, brush, padded cloth, and carpet material.

7. The sprayer assembly of claim 1 further comprising a filtering screen disposed at or adjacent the bottom container opening.

8. The sprayer assembly of claim 1 further comprising a spray gun in fluid communication with the spraying attachments.

9. The sprayer assembly of claim 1 further comprising a fluid divider having a fluid inlet and two fluid outlets wherein each of the two fluid outlets is in fluid communication with one of the two spraying attachments.

10. The sprayer assembly of claim 1 wherein the two sprayer attachments are spray guns having triggers connected to an activation mechanism for simultaneous activation of each of the spray guns.

11. The sprayer assembly of claim 1 wherein each of the two spraying attachments is angularly adjustable.

12. A portable shake sprayer kit comprising:
a container with an upper portion, a lower portion, a bottom container opening, and a top container opening wherein the upper portion has two openings spaced from each other;
a lid removably connectable to the top container opening, the lid including an elongated lid opening;
a wiping attachment removably connectable to the lid for disposing the wiping attachment at the elongated lid opening; and
two spraying attachments mountable to the two openings of the upper portion of the container wherein each of the two spraying attachments has a spray nozzle capable of being angularly disposed within the container;
two lengths of liquid supply tubing attachable to each of the two spraying attachments; and
a fluid divider having an inlet and two outlets wherein each outlet is attachable to one of the two lengths of liquid supply tubing and the inlet is attachable to a spray gun.

13. The kit of claim 12 further comprising a filter screen attachable at or adjacent to the bottom container opening

14. The kit of claim 12 wherein the lid includes a vent opening configured for connecting a detachable vent hose.

15. The kit of claim 12 wherein the lid is rotatable about the top container opening.

16. The kit of claim 12 wherein the wiping attachment includes one or more of a squeegee, roller, brush, padded cloth, and carpet material.
